(19) United States
(12) Patent Application Publication
(10) Pub. No.: US 2006/0081759 A1
(43) Pub. Date: Apr. 20, 2006

(54) Arrangement for producing molded concrete bricks

(76) Inventors: Rudolf Braungardt, Pechtelsgrun (DE); Erwin Schmucker, Schelkligen (DE)

Correspondence Address: WILLIAM COLLARD;COLLARD & ROE, P.C., 1077 NORTHERN BOULEVARD, ROSLYN, NY, 11576, US

(21) Appl. No.: 10/535,759

(22) PCT Filed: Oct. 24, 2003
(86) PCT No.: PCT/EP03/11783

§ 371 Date: May 20, 2005

(30) Foreign Application Priority Data
Nov. 21, 2002 (DE) 102 54 322.4

(51) Int. Cl. B28B 7/24

(52) U.S. Cl. 249/124; 249/128

(57) ABSTRACT

Disclosed is an arrangement for producing molded concrete bricks, comprising an insert (EI) that is disposed in an insert support which is fastened within a molding machine. Said arrangement is provided with an advantageous structure in the form of a hollow case that encompasses recesses (AP) so as to insert the arrangement into a base plate (GP) and a cover plate (DP). More specifically, the invention relates to particularly advantageous embodiments for producing the insert (EI) from folded metal sheets, fixing the insert (EI) inside the insert support, and fastening the insert support within the molding machine.

The invention relates to an arrangement for producing molded concrete bricks.

For the production of molded concrete bricks, a molding machine is typically used, in which a vibrating mold is set onto a vibrating table and filled with concrete mass, which is compacted under the effect of pressure and vibration movement. The vibrating molds for larger brick shapes, e.g. plant troughs, typically have an insert that determines the contour of the molded bricks to be produced, and an insert support to hold the insert in the molding machine. The insert is welded to the insert support. The insert support with insert is frequently structured in complex manner and is expensive.

The present invention is therefore based on the task of indicating an arrangement for the production of molded concrete bricks that possesses a simple and inexpensive structure.

The invention is described in claim 1. The dependent claims contain advantageous embodiments and further developments of the invention.

The structure of the insert support as a hollow case having a cover plate, a base plate at a distance from the latter, as well as side walls that run between the base plate and the cover plate, results in an uncomplicated structure having a low weight and, at the same time, a high level of stability. It is also particularly advantageous that the insert support can be standardized in its structure and that cutouts for the parts that form the case can easily be adapted to different conditions, by means of machine-specific and/or use-specific parameters.

It is advantageous if the base plate or at least the cover plate, preferably both, is/are part of a bent piece of sheet metal having at least three segments. In particular, the base plate and/or the cover plate continues towards at least two sides from the base plate or the cover plate, in the form of a bent piece of sheet metal. The case with the cover plate, base plate, and side walls advantageously consists of two modules that each contain a cover plate or a base plate, and at least one of which modules is structured as a bent, preferably multiply bent piece of sheet metal. Preferably, both modules are structured in U shape, with two side walls, in each instance, that follow the cover plate or the base plate at opposite edges, whereby the modules engage in one another with the openings of the U shapes facing one another, and rotated by 90° relative to one another, with reference to the surface normal line of the base plate and the cover plate. The components of the case, particularly the modules containing the cover plate, the base plate, and the side walls, are connected with one another, particularly welded to one another.

The structure of the case, made of bent pieces of sheet metal, is particularly advantageous, since flat pieces of sheet metal are used as the starting material and the contours for the bent sheets, including recesses, for at least one insert can be produced from them, inexpensively, e.g. by means of laser-beam cutting. Preferably, the bent pieces of sheet metal are produced by bending a flat sheet-metal cutout along a line. Other techniques for shaping a flat sheet-metal cutout into a body having partial surfaces oriented in different directions are known, in and of themselves, for example bending by means of rollers. By means of the bending along a line, three-dimensional structures can be produced from flat cutouts, inexpensively and with great precision; these structures can then be joined together, particularly welded together, preferably in the form of only two modules, supplementing one another, to form the case. The embodiment with two U-shaped modules is particularly advantageous in production, while at the same time having advantageous stability properties. The modules can advantageously be pre-finished, because of the high level of precision in the production of the flat sheet-metal cutouts and their bending, in such a manner that the modules support one another at sheet-metal edges and/or that their edges and/or surfaces reciprocally form hollow seams for welding the modules.

To further reinforce the case of the insert support, spacer elements can be provided between the base plate and the cover plate, which stand opposite one another vertically, at a distance from one another, which spacers are advantageously supported on the inside surfaces of the cover plate and the base plate. The spacer elements preferably project into openings of the base plate and/or the cover plate with projections, and can advantageously be welded to the base plate or the cover plate, in the openings. It is advantageous that the openings can already be pre-finished in the flat sheet-metal cutout. The spacer elements can be structured in the manner of pins or bolts, for example, and can support the cover plate and the base plate at certain points. In another embodiment, the support can also be over an area or in line shape. The spacer elements themselves can, in particular, also be formed as flat or also bent sheet-metal cutouts. In this connection, such sheet-metal cutouts can also be structured as slanted metal strips, and result in reinforcement in the manner of a supporting structure, by means of varying orientation. The spacer elements are preferably inserted into the modules that form the case, when they are joined together.

The insert (or, if applicable, the several inserts) is/are advantageously fitted tightly into the recesses of the cover plate and the base plate, and horizontally supported by the edges of the recesses. The recesses can already be produced in the flat cutouts, to the required extent, using available production techniques, e.g. laser cutting, but can also have a slight excess dimension for subsequent machining and be machined to their final dimension in a later production step, particularly only after the case has been assembled. It is advantageous if the insert is supported vertically on the base plate and/or the cover plate. For this purpose, the insert and/or the plate, in each instance, has/have a structure that corresponds to the other part, in each instance. Corresponding structures that engage in one another can be, for example, teeth, projections, depressions, steps, and the like.

An advantageous embodiment provides a step at the edge of the recess and/or at the edge of the insert, to support the insert on the inner surface of the base plate and/or the cover plate, whereby the embodiment with a step only along the edge of the insert is preferred.

According to an advantageous embodiment, the insert can be vertically supported on both opposite inner surfaces of the base plate and the cover plate, and for this purpose is advantageously inserted before the assembly of the case, between the baser plate and the cover plate. The edge of the insert then projects at least partly into the recess, or preferably projects beyond it, and can be fixed in place there, particularly welded. In another advantageous embodiment, the insert can also be vertically supported on only one inner surface. Preferably, a vertical support against an outer surface of the base plate and/or the cover plate is then additionally provided.

Another advantageous embodiment provides that the insert can be inserted from the side of the base plate or from the side of the cover plate, through the recesses, after the case has been assembled, and then vertically fixed in place. Preferably, again, a vertical support is provided on the base plate and/or the cover plate, which support can advantageously serve, at the same time, as a stop for insertion of the insert into the case. The support by means of the stop preferably takes place at the outer surface of the base plate. The embodiment with the insert that can be inserted into the finished case can be developed further, in advantageous manner, particularly to produce an embodiment in which the insert can be released from the case again, without destroying it, and replaced with a new insert. For the releasable vertical attachment of the insert in the insert support, in particular, it can be advantageous if the insert projects beyond the outer surface of the base plate or the cover plate in the insertion direction, and is fixed in place with a positive lock after insertion, on the outer surface. For this purpose, the insert can particularly have a structure that undercuts its edge that projects beyond the outer surface, preferably a circumferential groove, into which a counter-element engages releasably.

According to a preferred embodiment with an insert releasably fixed in place in the case of the insert support, the insert is inserted from below, through the base plate, into the assembled case, vertically, until it comes to a stop, and then projects beyond the cover plate of the case with its upper edge, by a dimension that is approximately equal to the thickness of the sheet-metal cover that is typically set on as a closure part. The edge that projects beyond the outer surface of the cover plate then advantageously has an undercut structure, preferably a circumferential groove. The sheet-metal cover, which is divided into at least two segments, contains the counter-structure to the undercut structure, in particular a stepped edge that follows the contour of the groove, which edge is inserted into the groove parallel to the outer surface, and is fixed in place on the cover plate by means of screwing down the sheet-metal cover.

A sheet-metal cover or another cover that can be attached to the cover plate can advantageously also serve to fix core holder rails that rest in slots of the edge of the insert and continue laterally beyond the insert, in slots of the cover plate, with a positive lock and preferably in releasable manner.

The insert support can be held in the machine, for example, in that flanges are affixed directly on opposite side surfaces of the insert support, particularly welded on, to form a connection with the machine. In another embodiment, structures for a releasable connection of the insert support with separate flange arrangements or with a molding frame can be formed on at least two opposite side walls of the insert support. Such structures can be formed, in a first advantageous embodiment, by means of an essentially horizontal groove that is made in a side wall, particularly milled in, which forms a tongue/groove arrangement with a flange-side tongue or a flange-side groove and a separate tongue, to fix the insert support in place on the flange or the molding frame. Another advantageous embodiment of such a structure provides that the side wall is shaped into a relief, particularly by means of bending it multiple times along preferably horizontal edges. The relief in the side wall achieved by means of bending can, in particular, form a projection and/or a depression relative to the vertical side wall surface, which corresponds to an adapted counter-relief on the side of the flange or molding frame, and overlaps horizontally with it, so that in the horizontal or preferably slanted progression of a relief surface of the case-side relief, a counter-relief surface runs lying above it, and the case can be pressed onto a base, particularly a vibrating table, by means of the effect of force on the flange side, downward, by means of a transfer of force between these surfaces, between which elastic material is preferably inserted. The case-side relief and the flange-side relief can, in particular, advantageously be triangular in cross-section. The production of a relief in the side walls of the case by bending a piece of sheet metal is particularly advantageous in connection with the structure of the case made of bent pieces of sheet metal, particularly of two pieces of sheet metal bent in a U shape.

Another advantageous releasable connection between the flange and the insert support, which is particularly adapted to the structure of the insert support as a hollow case, provides that relief structures are formed in opposite side walls that face the flanges, which structures correspond to counter-relief structures, whereby the relief structures and the counter-relief structures are pressed against one another by means of horizontal bracing of the flange arrangements against the side walls of the case, particularly by means of bracing elements located within the case and connected with the flange arrangements, preferably again having slanted contact surfaces and/or interposed elastic material. These bracing elements can also be inserted through openings in the side wall, in an advantageous embodiment. A preferred embodiment provides that the bracing elements are structured as rail pieces that can be inserted through oblong openings in the side wall and brought into a bracing position by turning them, in which position they can be braced against the side walls from the inside and press them against the flange arrangements,

In another embodiment, the flange can also be welded directly onto the side wall of the insert support. To absorb torques, it can be advantageous, in this connection, to provide junction plates in the interior of the insert support, which are connected with the side wall that bears the flange, on the one hand, and with the base plate and/or the cover plate, on the other hand, preferably by means of slot welding.

The invention is explained in detail below, on the basis of preferred exemplary embodiments, making reference to the figures. These show:

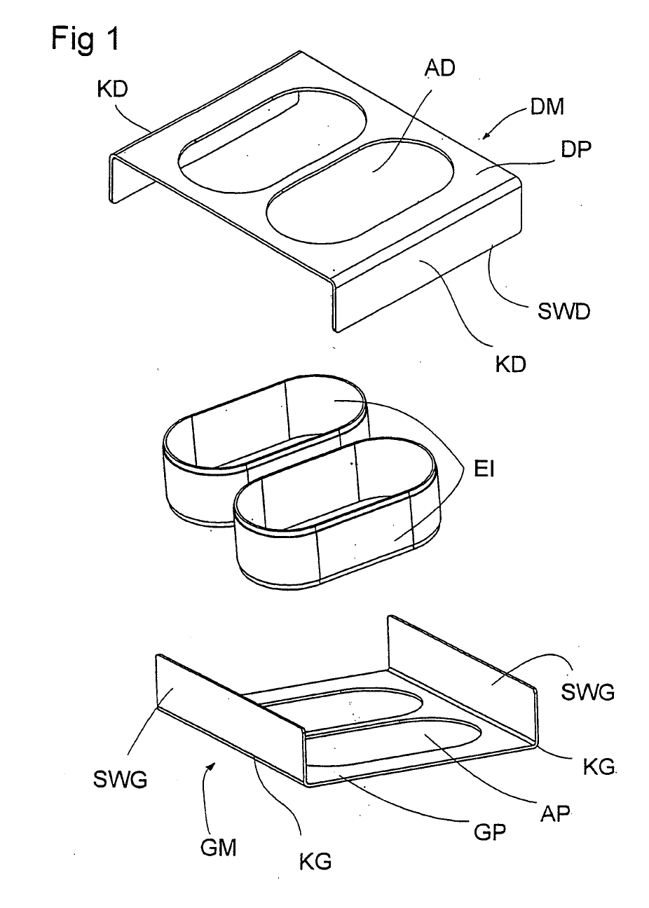

FIG. 1 a construction schematic of an insert support having two inserts,

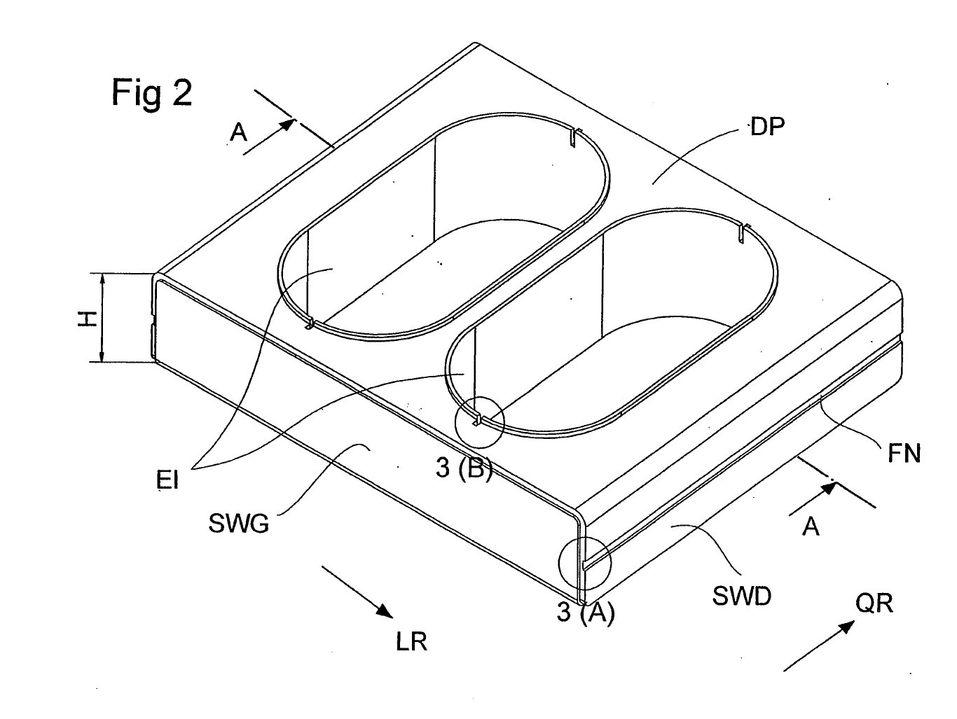

FIG. 2 the assembled arrangement of FIG. 1,

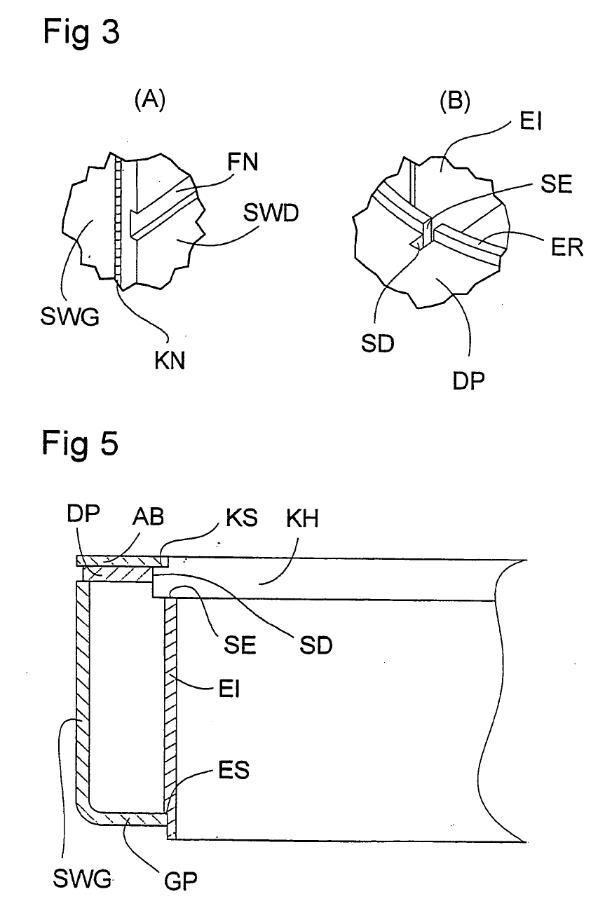

FIG. 3 detail views from FIG. 2,

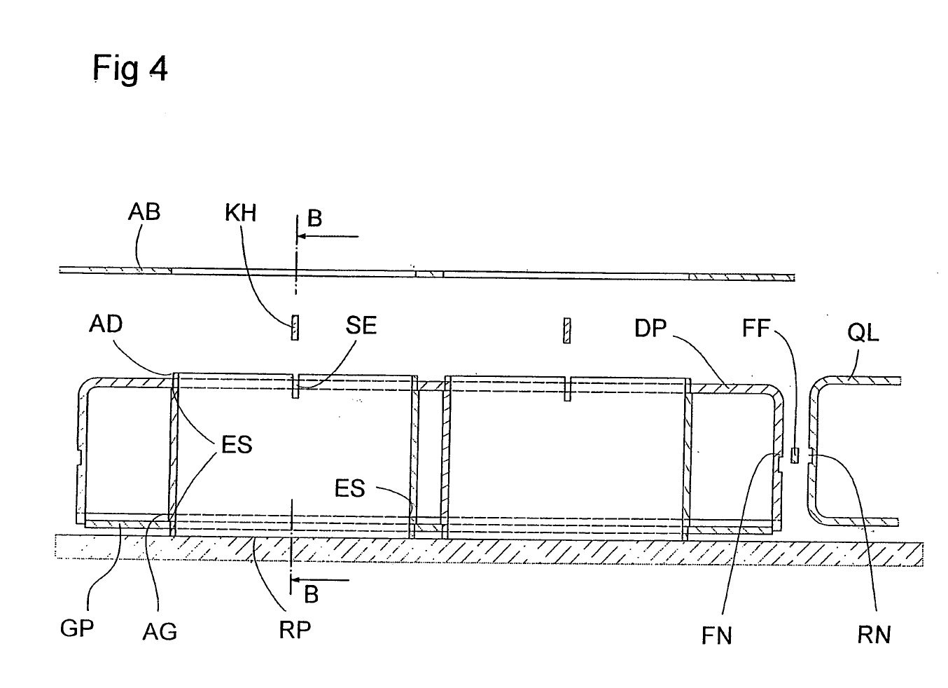

FIG. 4 a vertical cross-section through FIG. 2 along A-A,

FIG. 5 the fixation of a core holder rail,

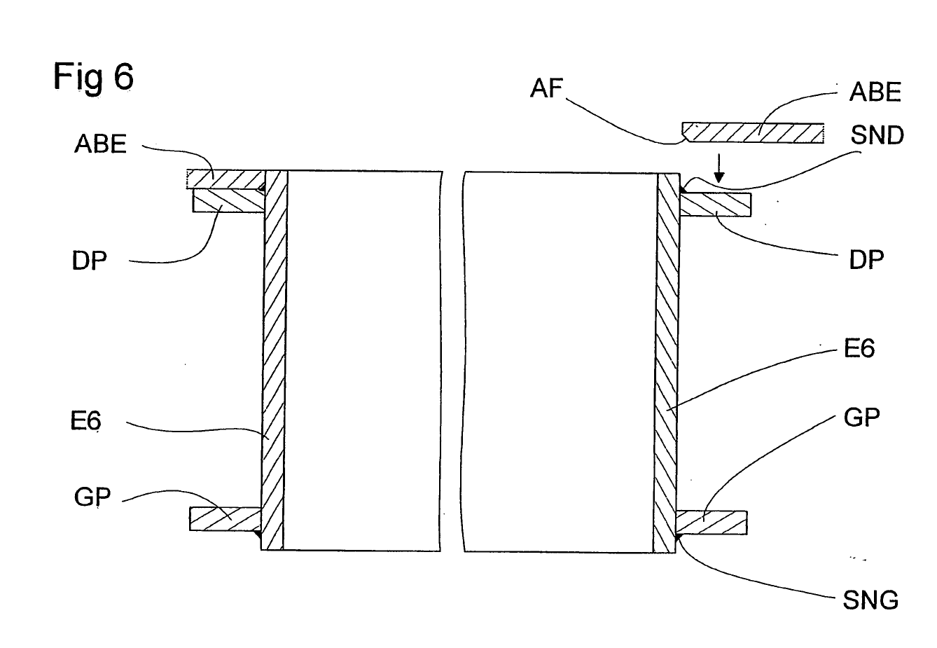

FIG. 6 an insert that has been welded in,

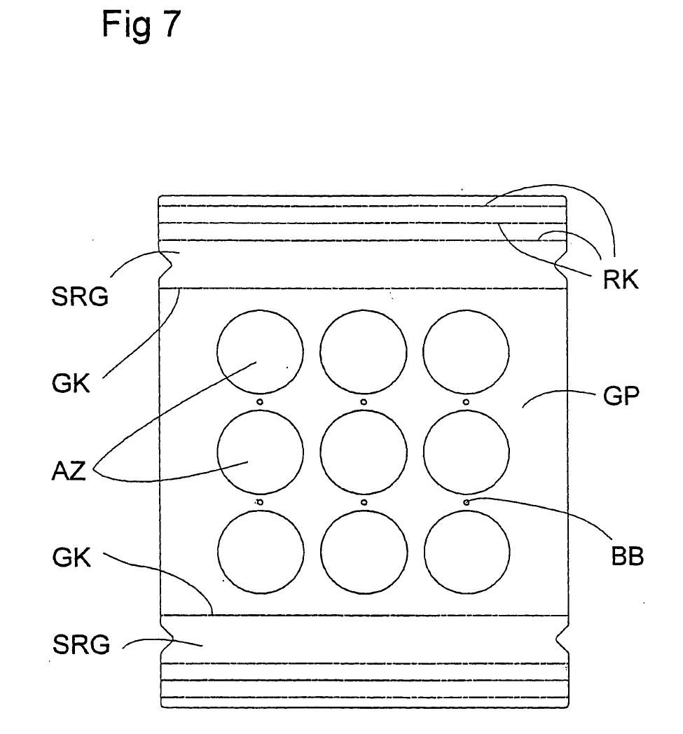

FIG. 7 a flat cutout of a piece of sheet metal for a module,

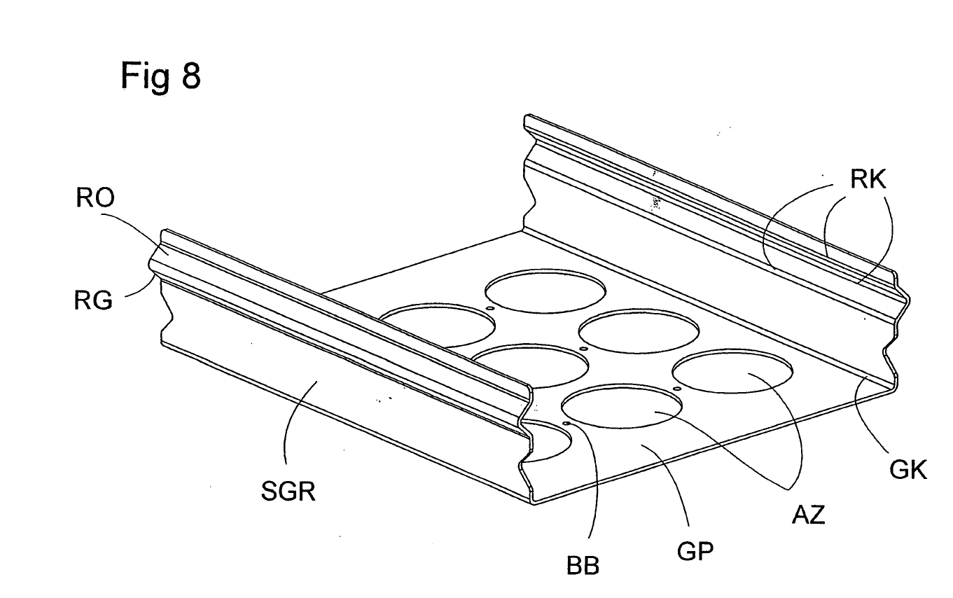

FIG. 8 the sheet metal from FIG. 7 after it has been bent several times,

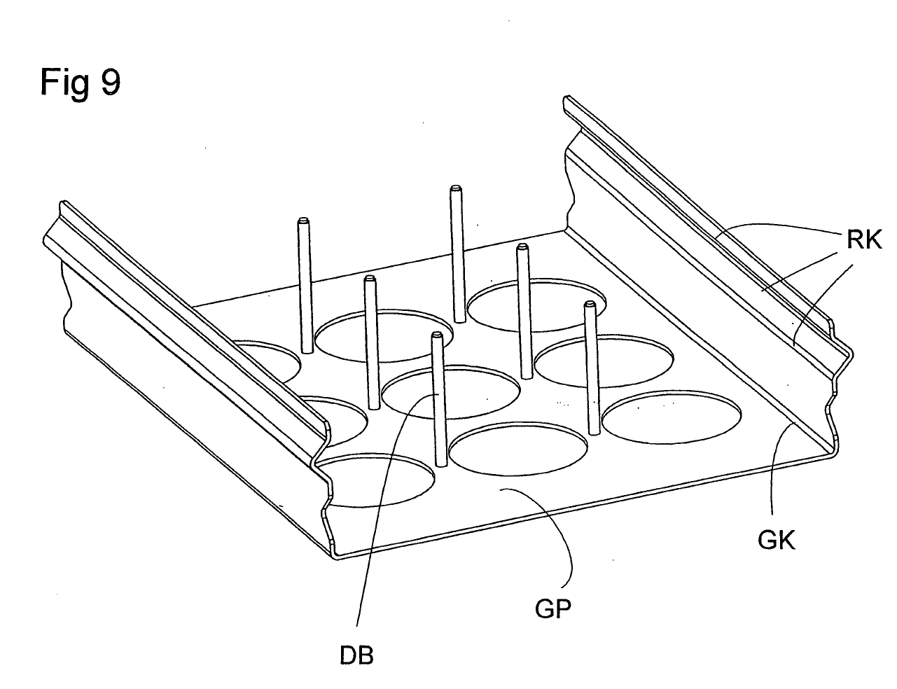

FIG. 9 the sheet metal according to FIG. 8 with spacer elements,

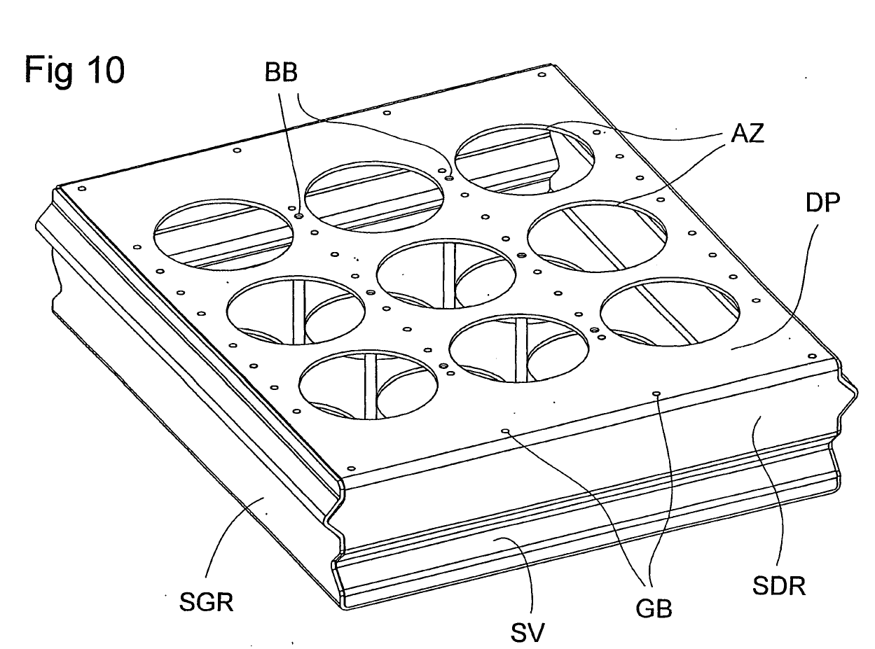

FIG. 10 a closed case from FIG. 9,

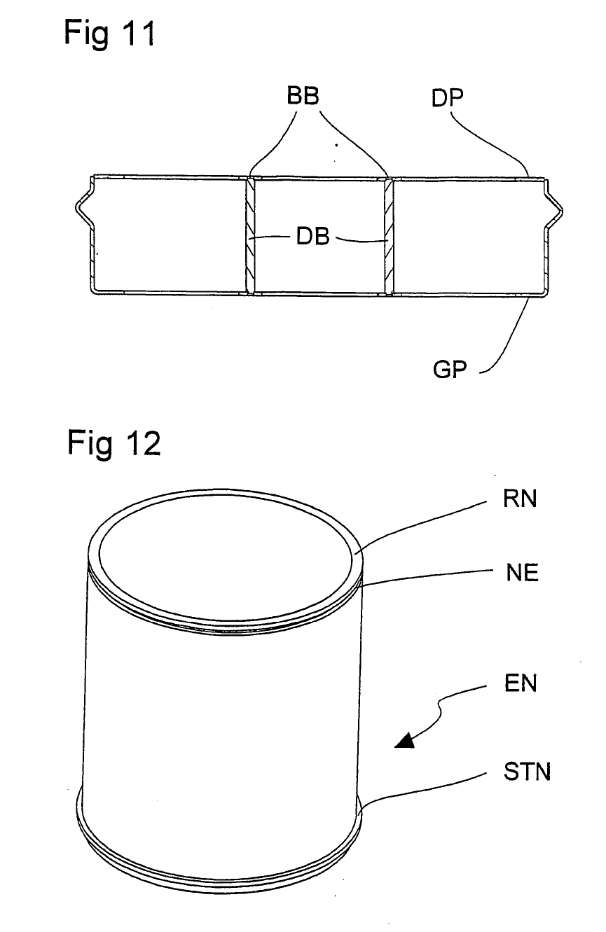

FIG. 11 a cross-section through the case according to FIG. 10,

FIG. 12 a circular insert,

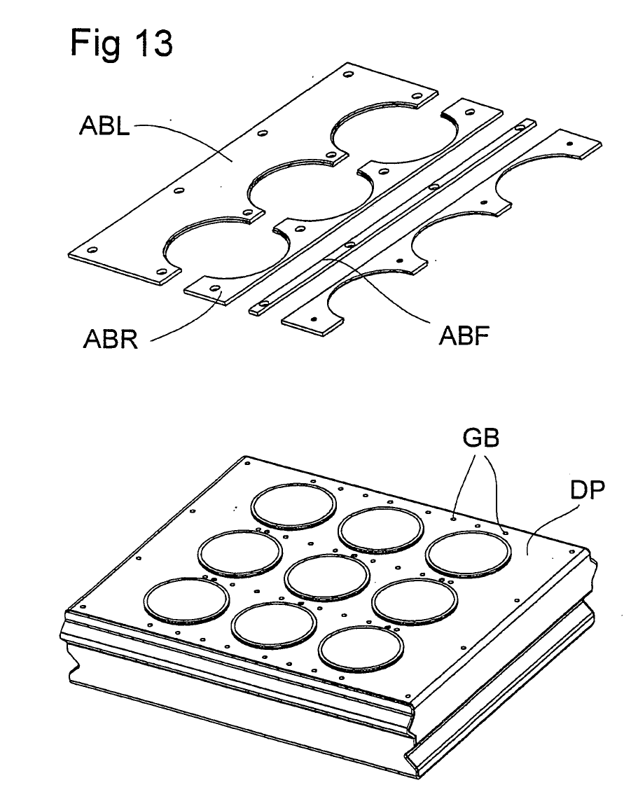

FIG. 13 an insert support with inserts and sheet-metal cover,

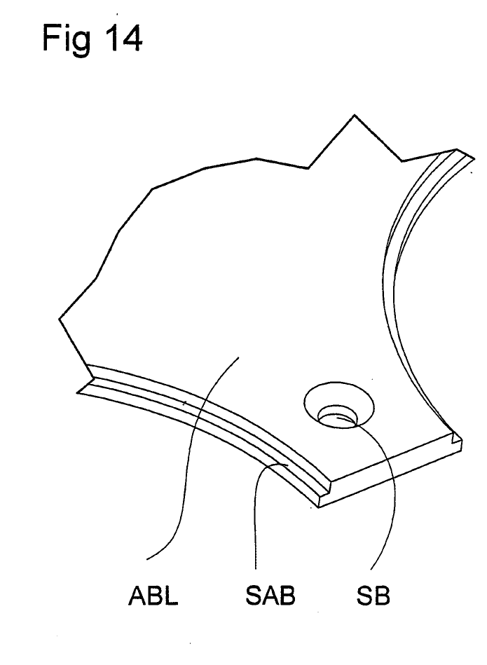

FIG. 14 a detail of a sheet-metal cover,

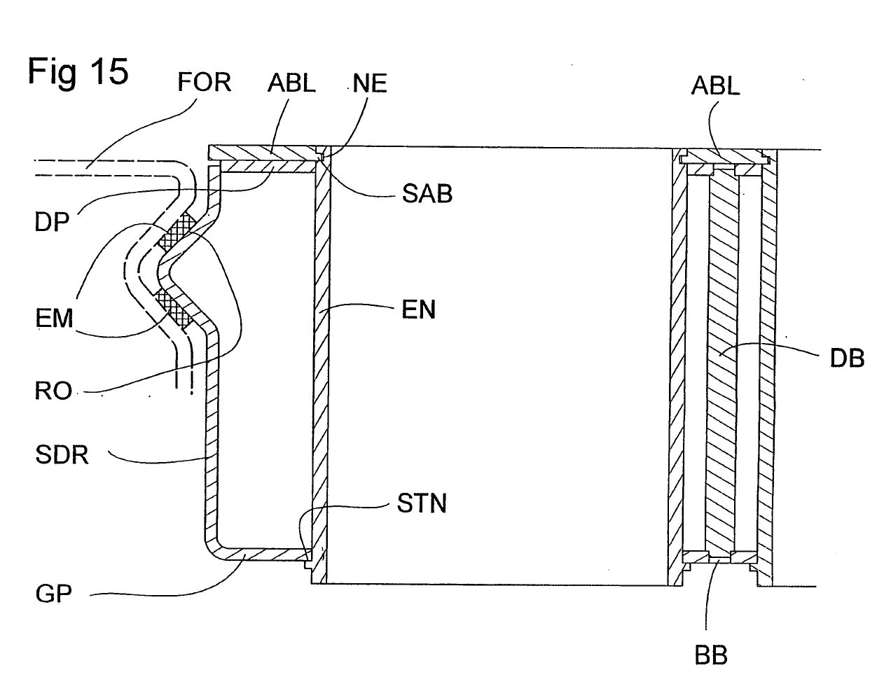

FIG. 15 a cross-sectional diagram with an insert releasably fixed in place,

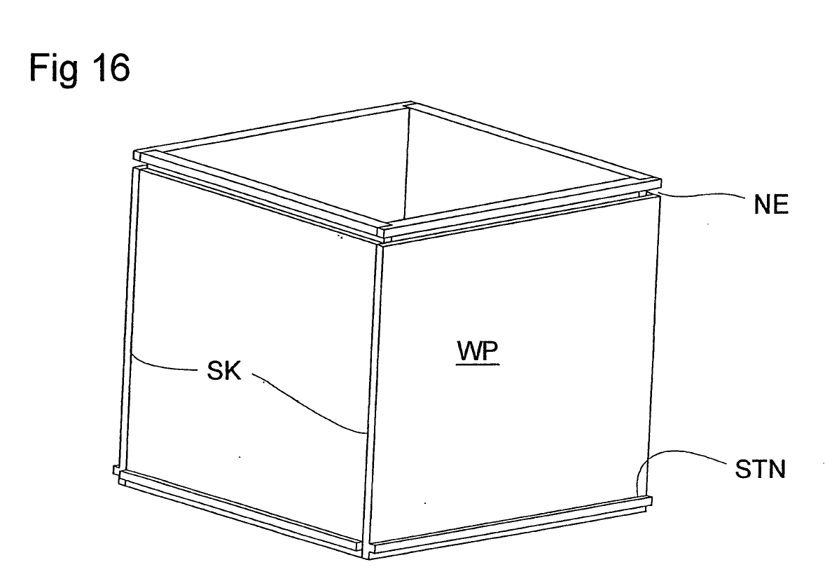

FIG. 16 an assembled insert,

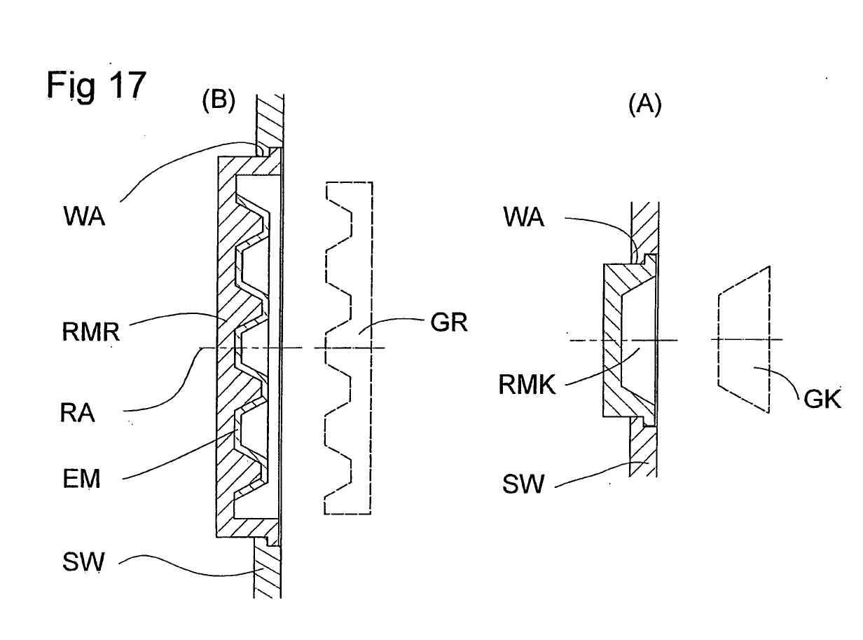

FIG. 17 relief inserts in side walls,

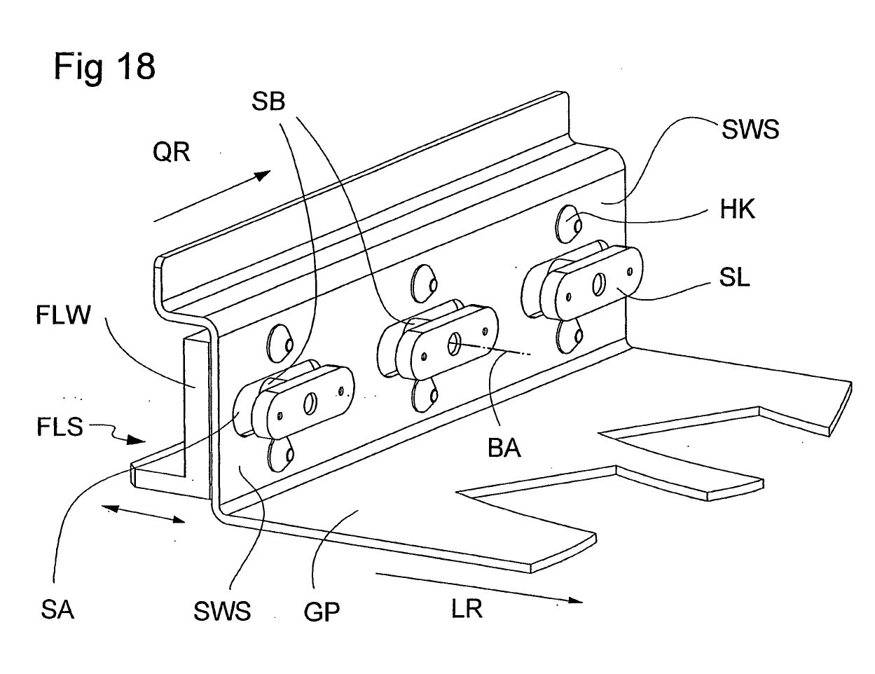

FIG. 18 an arrangement with bracing elements,

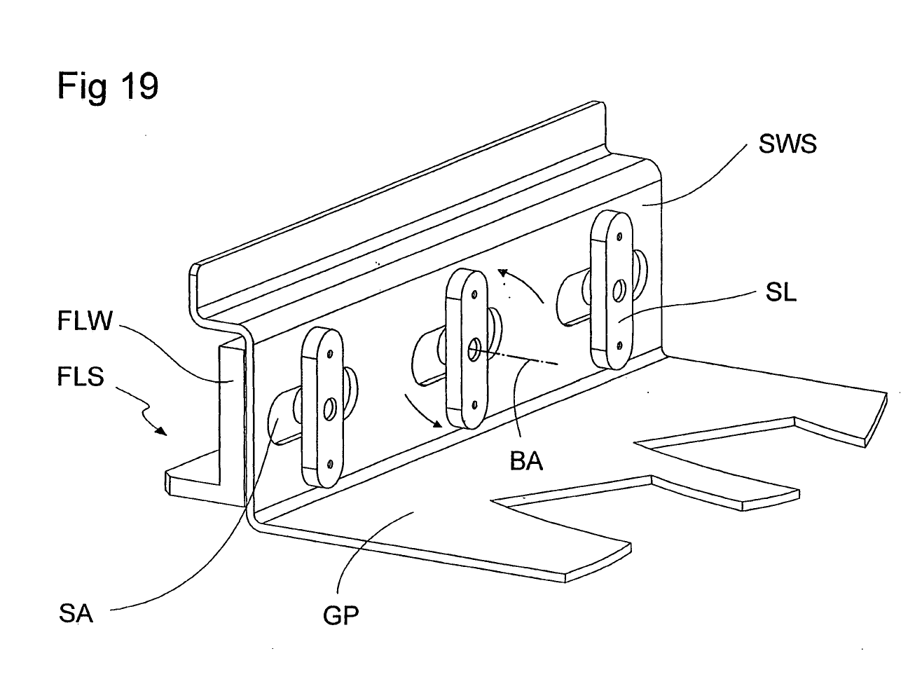

FIG. 19 the arrangement according to FIG. 18, braced,

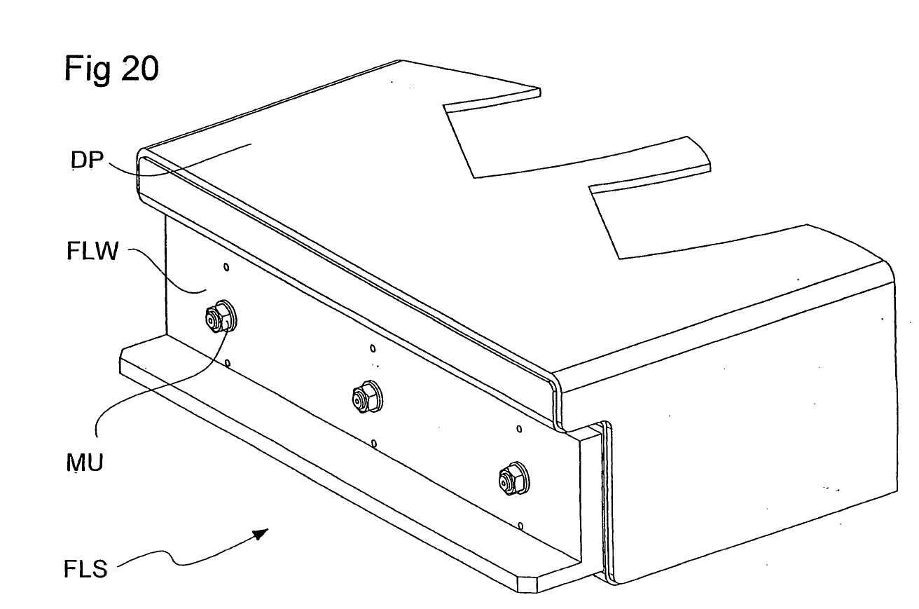

FIG. 20 the closed arrangement from FIG. 19, from the outside,

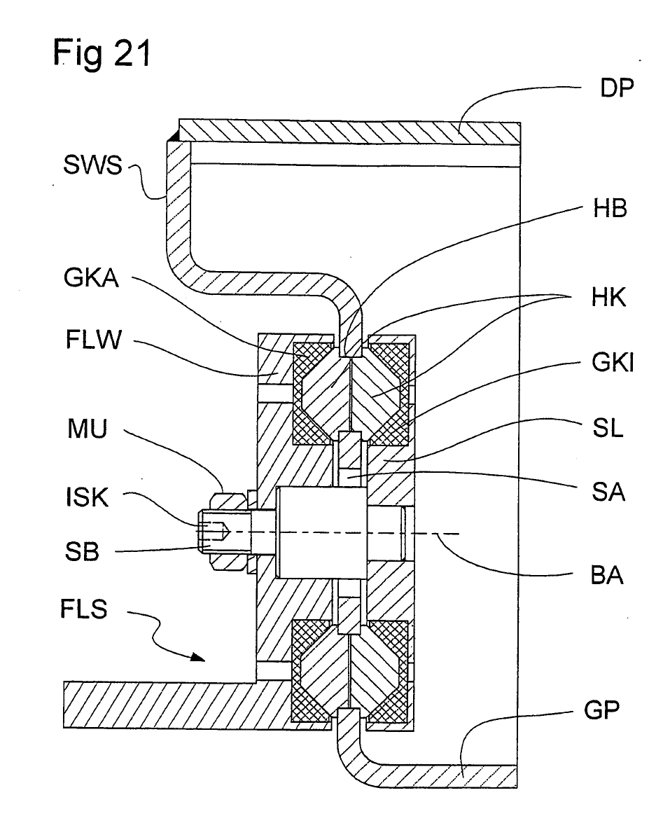

FIG. 21 a cross-section through the bracing,

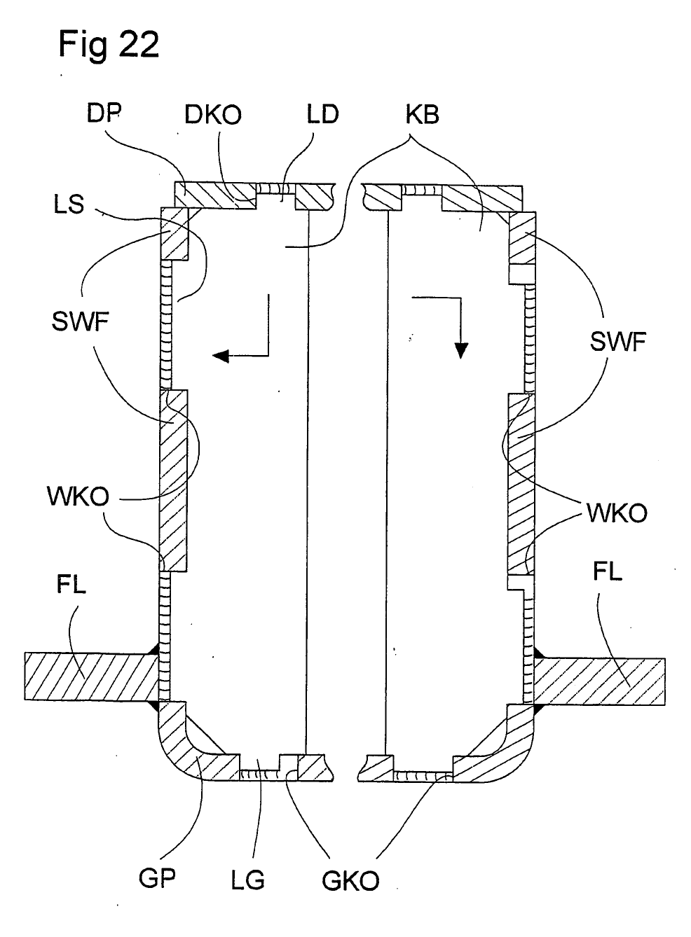

FIG. 22 a flange directly welded on,

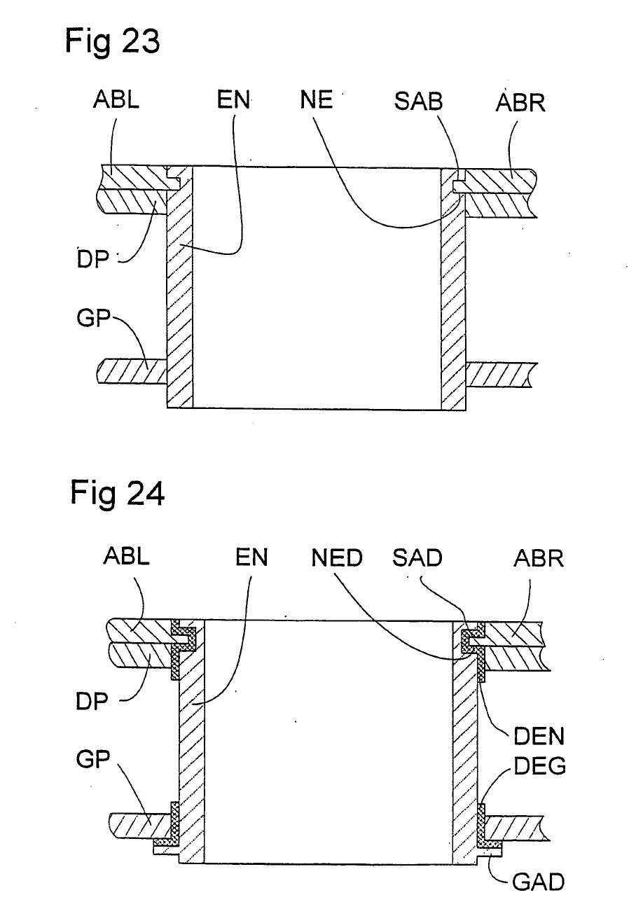

FIG. 23 another embodiment with an insert releasably fixed in place,

FIG. 24 an insert mounted with damping,

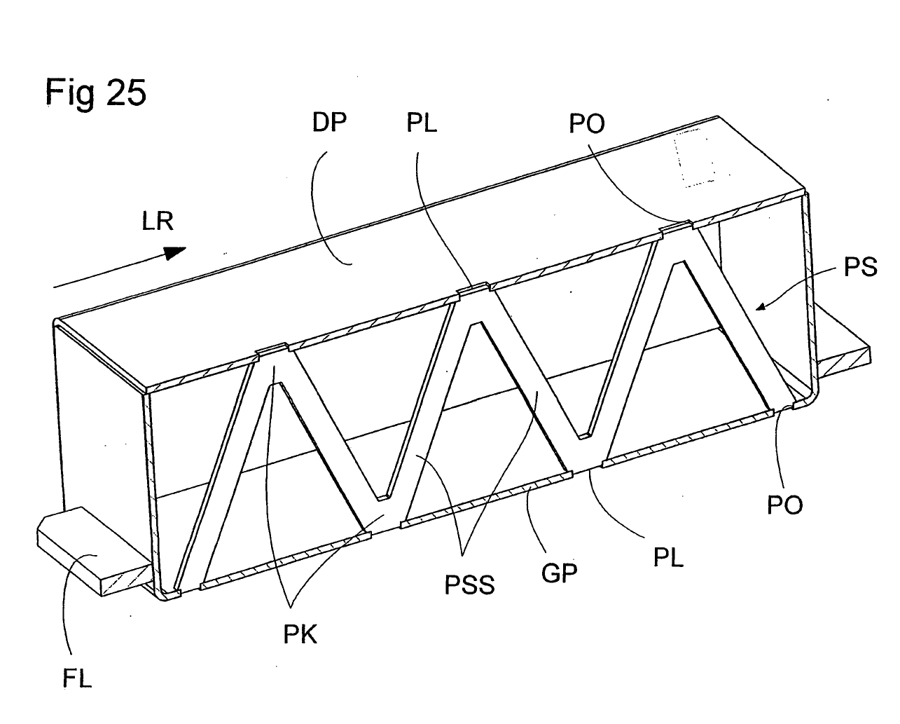

FIG. 25 a variant of a reinforcement structure.

Here and in the following, insert is understood to mean the component that determines the outside contour of the concrete part to be produced, with its inner wall, in contrast to the term molding insert for a component having several mold cavities separated by partitions and inserted into a molding frame, which is also a common meaning.

FIG. 1 shows individual components of an advantageous embodiment of the invention in an assembly of an insert support having two inserts EI, in a relative position that illustrates this assembly. Significant elements are a base module GM and a cover module DM. The base module contains an essentially rectangular base plate GP, which is followed by side wall plates SWG on two opposite edges. The base plate GP and the side wall plates SWG are attached along the edges KG, and the base module is produced from a one-piece flat sheet-metal cutout, preferably by means of bending at the edges KG. The side wall plates are bent essentially at a right angle to the plane of the base plate. The base module GM forms a U shape that is open towards the top.

In similar manner, a cover module DM that contains an essentially rectangular cover plate DP and side wall plates SWD that follow it on two opposite edges KD is formed from another flat sheet-metal cutout, by means of bending, and forms a U shape that is open towards the bottom. The side wall plates SWG and SWD, respectively, are directed at the other module, in each instance. The U shapes of the base module and the cover module are rotated by 90° relative to one another, with reference to the surface normal lines of the base plate and the cover plate. The U shapes can be assembled to form an essentially block-shaped case and connected with one another, particularly welded.

Recesses AP are produced in the base plate GP, and recesses AD are produced in the cover plate DP, preferably already as parts of the flat sheet-metal cutout. The recesses are provided and dimensioned to accommodate the inserts EI, which form continuous fill chambers for concrete material between the base plate and the cover plate.

FIG. 2 shows an assembled arrangement with two inserts of the type outlined in FIG. 1, in a slanted view. FIG. 3 shows detail views, FIG. 4 shows a cross-section along the line A-A of FIG. 2. The assembled U-shaped bent pieces of sheet metal that form the base module and the cover module supplement one another to form an essentially block-shaped case typically having different dimensions in the longitudinal direction LR and the crosswise direction QR, and a low height H, in comparison. A groove FN is made in the side walls SWD that extend in the crosswise direction QR, in each instance, which can serve to hold the insert support in a molding frame, according to one of different variants. In the cross-sectional diagram according to FIG. 4, a cross-rail QL of a molding frame is indicated on the right, and a groove RN is also made in its surface that faces the insert support. In the case of side surfaces of the cross-rail QL and the insert support that lie close to one another, a tongue FE made of metal and/or elastic material that rests in both grooves brings about a releasable vertical fixation of the insert support in the molding frame.

The groove FN can be seen once again, on a larger scale, in the detail according to FIG. 3A. This detail also shows that the cut edges of the bent pieces of sheet metal that form the base module and the cover module advantageously form a hollow seam KN that is particularly advantageous for welding. The cut edges can also deviate from the simple progression shown and can have auxiliary structures for a precise relative positioning of the base module and the cover module before welding, for example. Such auxiliary structures as well as other structures in the base module and the cover module can advantageously be produced in the flat cutout before it is bent.

In the detail according to FIG. 3B from FIG. 2, it can be seen that the upper edge ER of the insert projects beyond the cover plate DP, and has a vertical slot SE. As a continuation of this slot SE, a slot SD is also provided in the cover plate DP. The aligning slots serve to accommodate a core holder rail KH, which extends over the entire length of the insert and is attached on both sides. A core can be attached to the core holder rail, which projects into the filling chamber of the insert and forms a cavity in a finished concrete brick. An advantageous clamping fixation of a core holder rail is evident from FIG. 5, where a core holder rail KH that is inserted into the slots SE, SD has a step KS at the end, on the left in the sketch, which step is covered by a sheet-metal cover AB that is screwed onto the cover plate, and secures the core holder rail, which is supported in the slot SE towards the bottom, to prevent it from being loosened vertically.

In FIG. 4, an advantageous variant for fixing the insert in place in the insert support is outlined. Here, both the upper and the lower edge region of the insert are set back from the outer surface of the insert, and form steps ES, which are vertically supported on the inner surfaces of the cover plate DP and the base plate GP, at the edges of the recesses AD and AG, respectively, so that the insert is held clamped between the cover plate and the base plate. The steps ES are preferably circumferential around the entire insert.

The lower edge of the insert projects downward beyond the base plate and lies on a vibrating plate RP in operation, which plate can be the table plate of a vibrating table, for example, or another plate located on such a table. The insert is pressed onto the vibrating plate during the vibrating process, with great force, by way of the molding frame, the tongue/groove connection, and the insert support.

In FIG. 4, core holder rails KH and a sheet-metal cover before they are inserted and screwed on, respectively, are furthermore shown.

FIG. 6 shows a variant of the vertical fixation of an insert E6 in the insert support, in which the insert is welded to the insert support by means of weld seams SND, SNG between the outer wall of the edge segments of the insert that project out of the insert and the outer surface of the cover plate DP and the base plate GP, respectively. The sheet-metal cover ABE is beveled on (AF) at the edges that surround the border of the insert. Here, the insert is not vertically supported on the inner surfaces of the base plate or the pressure plate and can be inserted afterwards.

In FIG. 7, a flat sheet-metal cutout for a base module is sketched, for another advantageous exemplary embodiment, where a plurality of round openings AZ for round inserts is produced in the base plate GP. The openings in the flat sheet-metal cutouts can already have the final dimension for surrounding the inserts, but can also have a surplus of material for processing at the edges, which is removed to the final dimension in a subsequent machining step, with greater precision than in the case of the sheet-metal cutout, whereby special edge shapes, such as bevels, steps, etc., for example, can also be produced in addition during this final machining. Such an additional final machining can advantageously be performed together with the introduction of bores in the cover plate or the base plate, e.g. for screwing on the sheet-metal cover or for inserting spacer elements between the cover plate and the base plate. In the sketch, additional bending edges RK are drawn in with interrupted lines, in the region of the side wall plates, on the flat cutout, in addition to the bending edges GK at which the side wall plates make a transition into the base plate. These additional bending edges serve to produce a relief structure in the side wall plates, which will be illustrated in detail below, using examples. It is advantageous if the bending edges all run parallel. Bores or holes BB to accommodate spacer elements are also already prepared in the base plate.

FIG. 8 shows the sheet metal from FIG. 7 after it has been bent, as a base module. Several openings AZ as well as the additional bores BB for the insertion of spacer elements can be seen in the base plate GP. The side walls SGR have a relief RG in the form of projections having an essentially triangular or trapezoid progression after being bent several times along the additional bending lines RK, which relief projects outward from the vertical side wall progression, whereby the slanted relief surface RO that points upward is of particular advantage.

In FIG. 9, the base module of FIG. 8 is equipped with spacer elements DB that have been inserted into the bores BB, in the form of pins, for example, having a greater diameter in the center region and a smaller diameter in the end regions, which fits into the bores BB.

FIG. 10 shows the assembled insert support after a cover module has been set on, which is similar in structure and production to the base module. The cover module again has openings AZ and bores BB, particularly in the cover plate DP, additionally also threaded bores GB for screwing on a sheet-metal cover arrangement. The threaded bores GB can also be produced only after assembly of the case of the insert support, possibly together with final finishing of the openings. The side walls SDR of the cover module also show a relief that has been produced by multiple bending, in the example shown, which relief is implemented as a depression SV relative to the vertical plane of the side wall plate SDR here, and is vertically offset relative to the projections in the side walls SGR. The vertical edges of the side wall plates SGR and SDR, respectively, are spatially complex, following the relief structures, but can easily be indicated as lines in the cutout plane, for the developed view in the form of the flat cutout. The bending can be performed with sufficient accuracy so that a good fit of the two modules can be guaranteed, to form the approximately block-shaped insert support. Relief structures can also be present only on two opposite sides of the insert support, then preferably on the sides facing the flange rails, and advantageously on the side walls that continue the base plate.

FIG. 11 shows a sectional view through an assembled insert support according to FIG. 10, from which the position of the spacer elements DB between the base plate GP and the cover plate DP also becomes clear, in particular. The spacer elements can be welded into the bores BB.

FIG. 12 shows a circular insert EN that is pushed through the openings in the base plate and the cover plate from the side of the base plate GP of the insert support, and in this connection is closely surrounded by the edges of the openings, laterally, and supported horizontally. A radial step STN that is formed in the region of the lower edge of the insert EN delimits the insertion of the insert by means of a stop on the outer surface of the base plate GP, and when this stop is reached, the insert projects beyond the cover plate with an upper edge. In the region of the upper edge, a groove NE is made from the outer circumference of the insert, which groove undercuts the edge and also projects beyond the cover plate. The groove serves to fix the insert in place to prevent it from falling out downward, in that a locking element is pushed into the groove from the side. Preferably, a stepped edge of a sheet-metal cover segment serves as such a locking element.

FIG. 13 shows an insert support according to FIG. 10 with inserts pushed into it, as well as a sheet-metal cover arrangement consisting of several segments ABL, ABR, and ABF. The segments ABL and ABR each have arched edges that surround the inserts by half, which supplement one another. The arched edges have a vertical step SAB (FIG. 14), which engages into the groove NE in the region of the upper edge of the insert. For this purpose, the segments ABL, ABR are set onto the cover plate at a slight lateral distance from the inserts, and pushed against the inserts laterally. Because of the lateral displacements, gaps occur, which are closed by means of the strip-shaped filler segments ABF. Because of the stepped arched edges, the result can be achieved, without any additional elements, that the upper surface of the sheet-metal cover arrangement is approximately flush and with the upper edges of the inserts. Other possibilities for locking the inserted inserts in place are familiar to a person skilled in the art. The segments of the sheet-metal cover arrangement are screwed into place on the cover plate and have bores SB prepared for this purpose.

FIG. 15 shows a detail, in a cross-sectional diagram, of the fixation of an insert in the insert support. The insert, which has been pushed into the base plate from below, lies against the outer surface of the base plate GP with the step STN of its lower edge region, and is thereby prevented from any further movement upward. The step SAB of the sheet-metal cover segment ABL, which rests on the outer surface of the cover plate DP, which step engages in the groove NE of the upper edge region, prevents a shift of the insert downward, so that the insert is fixed in place in the vertical direction. Bending of the base plate and/or the cover plate towards one another is prevented by the spacer elements DB, which advantageously can be welded in place in the bores BB, from the outside.

At the left edge of FIG. 15, an advantageous embodiment of the holder of the insert support from FIG. 13 is also indicated in a molding frame FOR that is symbolized by a longitudinal rail or a cross-rail. A counter-relief that is adapted to the relief in the side wall SDR is formed in the molding frame, which counter-relief has at least one counter-surface that lies opposite the surface RO and overlaps the latter horizontally. By way of these surfaces, between which elastic material EM having a layer thickness between 2 mm and 10 mm is inserted, for example, vertical forces that are exerted on the insert support during the vibration operation of the molding frame can be applied to press the lower edge of the insert onto a vibration base, and vibration movements can be permitted within the scope of the compressibility of the elastic material. The counter-relief in the molding frame preferably supports the relief of the insert support in an upward and downward direction, as shown. The formation of a relief in a side wall of the insert support to hold the latter in a molding frame, by bending a piece of sheet metal that forms the side wall, is of particular advantage even independent of the U shapes of the base module and the cover module.

In FIG. 16, an insert constructed of several wall plates WP, which abut one anther along vertical butt edges SK, is shown, in which the several wall plates are profiled at their butt edges in such a manner that a displacement of the wall plates in the direction of the accommodation space enclosed by them is prevented. After the assembled insert has been inserted into the insert support, a movement of the wall plates away from the enclosed accommodation space is precluded, because of the tight fit in the openings of the cover plate and the base plate. The insert shown in FIG. 16, just like the round insert according to FIG. 12, shows a supporting step in the lower edge region and an undercutting groove in the upper edge region.

FIG. 17 illustrates another advantageous variant for holding an insert support having side walls SW in a molding frame. In this variant, relief modules RMK (FIG. 17A) and RMR (FIG. 17B), respectively, are inserted into wall openings WA. Counter-relief structures GK and GR, respectively, of longitudinal rails or cross-rails, respectively, which structures are horizontally displaceable in the direction of the wall surface normal line, engage into the relief structures of the relief modules in releasable manner, and fix the insert support in place, in the molding frame, in all directions, with a positive lock.

Different shapes are possible for the relief modules. In FIG. 17A, for example, a self-centering conical stump shape is shown. In FIG. 17B, the relief structure has several grooves that demonstrate rotation symmetry about an axis RA, having slanted flanks that are provided with elastic material EM. The relief modules and/or the counter-relief structures of the molding frame can consist of steel, other metals, high-strength plastics, or combinations of such materials. Elastic damping material, particularly such material having rubber-elastic properties, can be inserted between such metallic surfaces of relief and counter-relief.

In FIG. 18 to FIG. 21, another advantageous embodiment for holding an insert support in a molding machine is shown, which embodiment advantageously makes do without a molding frame that surrounds the insert support horizontally on all sides, and merely releasably braces flange arrangements laterally against side walls of the insert support, on opposite cross-sides. For this purpose, bracing elements rest against the inner walls of the side walls or on elements that are supported there. The bracing elements can be braced against flange arrangements, so that the outer surface of the side walls of the insert support is pressed in the direction of a vertical counter-surface of the flange arrangement, and in this connection, at the same time, is additionally fixed in place with a positive lock, crosswise to the surface normal line of the surfaces that are pressed against one another.

In FIG. 18, an insert support is opened up for the sake of clarity, e.g. shown only in the form of a base module with the base plate GP and side walls SWS. In the real case, the insert carrier is present as a closed case, as in the preceding examples.

Bracing rails SL are disposed on a vertical wall shank FLW of a flange arrangement FLS that extends in the crosswise direction QR, by way of pins SB, which rails fit through insertion openings SA in the side wall SWS of the insert support in the first orientation shown in FIG. 18, so that in this position of the bracing rails, these are displaced with the flange arrangement, in the direction of the double arrow and therefore in the longitudinal direction LR, and can be inserted into the interior of the case from the outside, for example, through the insertion openings. Several holding contours HK are provided on the inner surface of the side wall SWS, which can be implemented, for example, as elements fitted into holding recesses of the side wall. On the side of the bracing rails SL that face away from the viewer in FIG. 18, corresponding counter-contours GKI (see FIG. 21) are provided, the shape of which corresponds to the shape of the holding contours HK and which can be laid flat against the holding contours, with a positive lock. The holding contours and the counter-contours preferably lie symmetrical to the horizontal axes of rotation BA of the pins SB, in pairs.

By rotating the pins SB about their horizontal longitudinal axes BA by 90°, preferably by way of a hexagon socket ISK in the pin, the bracing rails SL are brought into the position that can be seen in FIG. 19, in which the holding contours and the counter-contours stand directly opposite one another and can be brought to rest flat against one another. Preferably, holding contours are also provided on the outer surface of the side wall, and corresponding counter-contours GKA are provided on its wall shank FLW of the flange arrangement (see FIG. 21). The pins SB are pulled out and braced, for example by means of rotating nuts MU that are screwed onto threads of the pins SB and braced on the wall shank FLW on the outside, which nuts can be seen in the view according to FIG. 20, so that the holding contours and the counter-contours engage into one another with a positive lock and are firmly pressed against one another in the direction of the surface normal line of the side wall SWS and the wall shank FL. This bracing situation is made clear in the cross-sectional diagram according to FIG. 21. In this connection, the holding contours HK are implemented as dual elements having a conical stump shape, which are fitted into holding recesses HB of the side wall from both sides. The counter-contours GKI in the bracing rails SL and GKA in the wall shank FLW are implemented as inserts into accommodations of the bracing rails and the wall shank, respectively. This advantageously allows a broad variation of the material pairings. In particular, in a preferred embodiment, the holding contours HK as well as the bracing strips SL and the wall shank FLW can be metallic, and the inserts for the counter-contours GKI and GKA can consist of plastic.

The holding contours and the counter-contours can also be provided on only one side of the side wall, whereby a positive-lock cross-anchoring on the outer surface of the side wall SWS with the wall shank FLW of the flange arrangement is particularly advantageous. The shaping and positioning of the contours that engage into one another is accessible to a plurality of variations. In particular, projections and depressions of the contours can also be exchanged as compared with the example shown in FIG. 21. It is particularly advantageous to provide the contours also spaced apart in the vertical direction, in the surface of the side wall. Holding contours can also be formed directly in the side wall, e.g. in the form of depressions. Instead of the bracing rails, other components that support themselves on the inner surface of the side wall can also be used. Such components, which can also be only screws, nuts, threaded sleeves, etc., in the simplest case, can also be inserted and firmly connected with the side wall before the case of the insert support is closed, so that only the connection with such elements, which are present in a fixed state, is produced for attaching the flange arrangement.

FIG. 22 shows an embodiment in which flange rails FL are directly and firmly connected with opposite side walls of the insert support, particularly welded. FIG. 22 shows an edge region of the assembled insert support, in each instance, in the left half and the right half, without showing the insert itself. The explanations with regard to the preceding examples apply to holding an insert, and they can be transferred here without restrictions. The flange rails are preferably welded onto the side walls SWF that continue the base plate GP laterally, in an upward direction. To absorb torques about the horizontal longitudinal axis of the flange rails, which can assume significant values, particularly during vibration operation, it is advantageous that junction plates can be inserted into the inside of the cavity and advantageously firmly connected with the side walls SWF, on the one hand, and with the base plate GP and/or the cover plate DP, on the other hand. For a firm connection of the junction plates with the side walls and the base plate and/or the cover plate, the junction plates are advantageously continued in the form of tabs LS, LG, LD, as shown in the example, which tabs project into corresponding slots WKO of the side walls and GKO and DKO of the base plate and the cover plate, respectively, and can advantageously be fixed in place there by means of slot welding. The junction plates are set into the base module before the cover module is set onto the latter, whereby the tabs that face the side wall and/or the base plate are shortened as compared with the lengths of the recesses WKO and GKO, respectively, so that in the embodiment in the left half of FIG. 22, the junction plate is inserted into the recess GKO vertically with the tab LG pointing downward, and then pushed into the recesses in the side wall towards the left. In the example in the right half of FIG. 22, the junction plate is first inserted laterally into the recesses WKO of the side wall SWF, with the tabs LS, and then pushed downward, whereby the tab LG, which points downward, engages into the recess GKO of the base plate.

FIG. 23 and 24 show variations of the holder of an insert in the insert support shown in FIG. 15. In the embodiment according to FIG. 23, it is provided that the insert EN is not supported on the base plate and that forces that act upward and downward are absorbed exclusively by means of the engagement of the groove NE and the projection SAB, by way of the sheet-metal cover segments ABL, ABR that are attached to the cover plate DP. Such a hold can be provided, in particular, in cases of use where the work is carried out with low vibration power.

FIG. 24 shows an embodiment in which damping material, for example in the form of a lower damping profile DEG and/or an upper damping profile DEN, is inserted between opposite surfaces of the insert EN, on the one hand, and the base plate, cover plate, and sheet-metal cover, on the other hand. The damping material can, as shown, be inserted between all the contact or support surfaces, but can also be restricted to a part of these surfaces, for example to surfaces that absorb vertical forces and/or to surfaces for forces that press the insert downward, in the case of the damping means DEG, and forces that lift up, in the case of the upper damping means DEN. To enlarge the surfaces that transfer force, particularly those that transfer vertical forces, the projections GAD in the lower edge region of the insert and/or SAD in the steps of the sheet-metal cover segments can be dimensioned to be radially larger than in the example according to FIG. 15. The damping profile DEN can also be used as an individual element in the example of FIG. 23, for example.

FIG. 25 shows a different advantageous reinforcement of the insert support, with a view into an insert support that has been cut open. Here, a plate element PS having several struts PSS that run at a slant is provided, which element engages in recesses PO of the cover plate DP and the base plate GP with tabs PL, at the nodes PK of struts that run together, and is fixed in place there, preferably by means of slot welding. As compared with a flat, continuous plate, the element PS, which can advantageously be cut from a flat plate, has the advantage of saving material and weight. Such a reinforcement with one or more plate elements that run in the longitudinal direction LR is particularly advantageous, but without being restricted to only one or this direction. The shape of the plate element PS, in detail, is accessible to a great variety of designs.

The characteristics indicated above and in the claims, as well as evident from the figures, can advantageously be implemented both individually and in various combinations. The invention is not limited to the exemplary embodiments described, but rather can be modified in many ways, within the scope of the skills of a person skilled in the art. In particular, the structure of the insert support, being made of bent pieces of sheet metal, the attachment variants of inserts in an insert support, and the hold of the insert support in a molding machine, are essentially independent of one another, and the characteristics and examples described in this connection can be combined in many different ways.

1. Arrangement for producing molded concrete bricks, having at least one insert that determines the contour of a molded brick, and an insert support to hold the insert in a molding machine and to press the insert against a vibrating base, wherein the insert support is structured as a hollow case that is rigid to resist twisting, having a base plate, a cover plate, and side walls, in the base plate and cover plate of which recesses for accommodating the insert are present, and that the insert is horizontally supported by the edges of the recesses and vertically supported on the base plate and/or the cover plate.

2. Arrangement according to claim 1, wherein the cover plate and/or the base plate are part of a bent piece of sheet metal, having at least two side wall parts that face the other plate, in each instance.

3. Arrangement according to claim 1,wherein the cover plate and the base plate are, in each instance, the center part of one of two pieces of sheet metal bent in U shape, and engage into one another with the openings of the U shapes facing one another, rotated by 90°.

4. Arrangement according to claim 1, wherein spacer elements are inserted within the case, at a distance from the insert, between the cover plate and the base plate.

5. Arrangement according to claim 4, wherein the spacer elements are supported on the inner surfaces of the cover plate and the base plate, and project into openings in the base plate and the cover plate with projections.

6. Arrangement according to claim 4, wherein the spacer elements are welded to the base plate and/or the cover plate.

7. Arrangement according to claim 1, wherein the insert supports itself on the inner surface of the base plate and/or the cover plate.

8. Arrangement according to claim 1, wherein the insert is pushed through the recesses of one of the plates from the outside, until it comes to a stop on a first one of the two plates, and is attached to the second of the two plates.

9. Arrangement according to claim 1, wherein the insert is welded to the base plate and/or the cover plate.

10. Arrangement according to claim 1, wherein the insert is releasably inserted into the case, in destruction-free manner.

11. Arrangement according to claim 1, wherein the insert projects beyond the base plate and/or the cover plate.

12. Arrangement according to claim 11, wherein the insert projects beyond the cover plate and that its upper edge lies essentially in a plane with the upper surface of a sheet-metal cover arrangement.

13. Arrangement according to claim 12, wherein the part of the insert that projects beyond the cover plate has an undercut and that an edge of the sheet-metal cover engages in the undercut.

14. Arrangement according to claim 1, wherein elastic damping material is inserted between the insert support and the insert.

15. Arrangement according to claim 1, wherein the insert has a slot for accommodating a core holder.

16. Arrangement according to claim 15, wherein the slot and the core holder continue into the cover plate and that the core holder is supported downward in the slot of the insert and upward by means of a sheet-metal cover arrangement that is attached onto the cover plate.

17. Arrangement according to claim 1, wherein at least two opposite side walls have a relief for holding the case in a corresponding counter-relief of a molding frame.

18. Arrangement according to claim 17, wherein the relief comprises a groove milled into a side wall.

19. Arrangement according to claim 17, wherein the relief is formed by multiple bending of sheet-metal segments that form the side walls.

20. Arrangement according to claim, wherein the case and the counter-relief of the molding frame overlap horizontally and that damping means are inserted between vertically opposite surfaces of the relief and the counter-relief.

21. Arrangement according to claim 1, wherein bracing elements rest against side walls of the case from the inside, and brace them against counter-surfaces of a flange arrangement from the outside, with a positive lock.

22. Arrangement according to claim 1, wherein flange rails are firmly connected with the insert support, on opposite side walls, for clamping into the molding machine.

23. Arrangement according to claim 22, wherein junction plates are connected with the side walls as well as the cover plate and/or the base plate, in the interior of the insert support.
